(19) United States
(12) Patent Application Publication
(10) Pub. No.: US 2012/0032122 A1
(43) Pub. Date: Feb. 9, 2012

(54) METHOD FOR FORMING A CADMIUM CONTAINING NANOCRYSTAL

(75) Inventors: Yun Zong, Singapore (SG); Mingyong Han, Singapore (SG); Wolfgang Knoll, Mainz (DE)

(73) Assignee: AGENCY FOR SCIENCE, TECHNOLOGY AND RESEARCH, Singapore (SG)

(21) Appl. No.: 12/672,270

(22) PCT Filed: Aug. 6, 2007
(86) PCT No.: PCT/SG07/00235

§ 371 Date: Oct. 28, 2011

(51) Int. Cl. H01B 1/06; C01G 11/02; C01B 19/04; B82Y 40/00; B82Y 30/00

(52) U.S. Cl. 252/519.4; 423/566.1; 423/509; 977/700; 977/774; 977/896

(57) ABSTRACT

The present invention provides a method of forming a nanocrystal of the composition CdA, with A being S or Se. The method includes forming in a suitable solvent a solution of cadmium, or a compound thereof, in a form suitable for the generation of a nanocrystal. The solvent includes a compound selected from an ether and an amine. The method further includes bringing the solution to a temperature selected in the range from about 20° C. to about 200° C. The method also includes adding at the temperature selected in the range from about 20° C. to about 200° C. the element A in a form suitable for the generation of a nanocrystal. Thereby the forming of a nanocrystal of the composition CdA is allowed.

The present invention relates to a method of forming a nanocrystal which includes cadmium.

Inorganic nanoparticles find a wide range of applications including e.g. as coloring agents (e.g. in stained glass windows), catalysts, as magnetic drug delivery, hypothermic cancer therapy, contrast agents in magnetic resonance imaging, magnetic and fluorescent tags in biology, solar photovoltaics, nano bar codes or emission control in diesel vehicles.

Semiconductor nanoparticles, typically nanocrystals, that confine the motion of conduction band electrons, valence band holes, or excitons (in all three spatial directions) can serve as “droplets” of electric charge and are termed quantum dots. Quantum dots can be as small as 2 to 10 nanometers, with self-assembled quantum dots typically ranging between 10 and 50 nanometers in size.

Quantum dots have attracted interest for various uses, including electronics, fluorescence imaging and optical coding. They are of particular importance for optical applications due to their theoretically high quantum yield. In electronic applications they have been proven to operate like a single-electron transistor and show the Coulomb blockade effect.

Solid state lighting devices such as light-emitting diodes (LEDs) have become an application for quantum dots. The efficiency of LEDs very much depends on the quality of their emitting layers, which traditionally, are inorganic layers prepared via physical evaporation or molecular beam epitaxy approach. The merit of these LEDs is the photostability, providing long life-time for the devices; the drawbacks were expensive facilities, critical fabrication conditions, and low efficiency. The use of organic and polymeric dye as the emitting layer increased the efficiency and makes the fabrication easier; however, the low stability of these dyes at elevated temperature or in presence of light shortened the life-time of the device dramatically. Colloidal quantum dots with high Quantum Yield and of easy-processible character provided the possibility of producing LEDs with both the merits of inorganic and organic LEDs prepared previously, i.e., using quantum dots embedded polymer matrices (aka, polymer/quantum dots nanocomposite, polymer/quantum dots hybrid materials, etc) as emitting layers (Achermann, M., et al., Nature [2004] 429, 642-646).

One of the most successful routes to prepare high-quality semiconductor quantum dots is the decomposition of molecular precursors at high temperatures in a coordinating solvent (for an overview of previous techniques see e.g. Reed, M. A., Scientific American (1993), January, 118-123), possibly, in the presence of a negative ion source, e.g., TOP/Se, TOP/S, etc. This process was developed in 1993 by Murray et al. (J. Am. Chem. Soc. (1993), 115, 8706-8715) and yields quantum dots of CdE (E=Se, S, and Te). It involves the formation of a solution of dimethylcadmium in tri-n-octylphosphine (TOP) and a solution of the corresponding chalcogenide in TOP. The solutions are combined and rapidly injected into tri-n-octylphosphine oxide (TOPO) at high temperatures (200° C.-300° C.). Thereby TOP/TOPO capped nanocrystals are obtained. The capping agent allows particle solubility in organic solvents, and plays a crucial role in preventing particle aggregation and electronically passivating the semiconductor surface. A similar approach has been also used for the preparation of ZnS and ZnSe nanoparticles, CdSe/ZnS, CdSe/CdS, and CdSe/ZnSe with core/shell nanostructures. CdSe nano crystals have become the most extensively investigated quantum dots because of their ease of preparation and size-tuneable photoluminescence across the visible spectrum.

This so-called TOPO method permits the production of highly monodisperse nanoparticles in quantities of hundreds of milligrams in one single experiment. However a great hindrance for its development on a large scale is represented by the high temperatures employed and by the toxicity of the starting materials.

Most of the illumination used in daily life resembles sunlight, i.e., white-emission. This explains the demand in developing white-emitting materials. White-emitting polymer/quantum dots hybrid materials have also been demonstrated. The most widely applied strategy was to mix quantum dots with different size thus providing the emission of different colours into a polymer matrix to achieve an overall white light emission, following the R-G-B principle (i.e., mixture of red-green-blue light leads to white light). Such a strategy, however, may be limited due to some potential problems: 1) possibility of the inhomogeneous distribution of the quantum dots with different colours within the matrix, leading to domination or deficiency of one single colour in certain sections; 2) difficulties in controlling inter-particle distances, resulting in fluorescence resonance energy transfers (FRET) in which the light emitted with short-wavelength is absorbed by larger size particle. Deficiency of the short wavelength emitting light leads to failure of the white light formation. Reducing the concentration of the quantum dots in polymer matrix might reduce the FRET possibility, but does not necessarily help white-light emission; 3) device performance failure if three types of quantum dots show different photo- or thermal stabilities. All these limit the application of quantum dots to a large extent.

A solution for the above-mentioned problems appeared in 2005 (Bowers, M. J., J. Am. Chem. Soc. [2005] 127, 15378-15379). In this report quantum dots with ‘magic size’ were prepared in a modification of the TOPO method. Into a solution of cadmium oxide and dodecylphosphonic acid in a mixture of TOPO and hexadecylamine a solution of selenium in TOP and octadecene was injected at high temperatures (330° C.). Due to the rich surface states these quantum dots emitted light with long wavelengths besides their intrinsic emission in the blue light range. The overall emitted light was a pure white light. Though white emitting quantum dots can be prepared following this approach, the required critical reaction conditions and operation make it impossible for scale-up productions. A new approach for producing similar quantum dots at mild conditions with easy operation is necessary.

Another problem preventing quantum dots (even the coloured ones) from wide use is the high cost, which is a consequence of the difficulties in preparation (high temperature, harsh treatment, etc), purification (exhaustive washes with high consumption of solvents and effort), and the scale-up problems. Therefore there exists a need for new approaches helpful for lowering the production cost of quantum dots.

It is therefore an object of the present invention to provide a method that provides at least essentially monodisperse nanoparticles of a cadmium chalcogenide that overcomes at least some of the above explained difficulties.

In one aspect the present invention provides a method of forming a nanocrystal of the composition CdA, with A being S or Se. The method includes forming in a suitable solvent a solution of cadmium, or a compound thereof, in a form suitable for the generation of a nanocrystal. The solvent includes a compound selected from an ether and an amine. In some embodiments the solvent includes an alkene. Furthermore the solvent is at least essentially free of tri-n-octylphosphine oxide. The method includes bringing the solution to a temperature selected in the range from about 20° C. to about 200° C. The method also includes adding at the temperature selected in the range from about 20° C. to about 200° C. the element A in a form suitable for the generation of a nanocrystal. Thereby the forming of a nanocrystal of the composition CdA is allowed.

According to some particular embodiments, forming a solution of a cadmium compound is carried out by forming a cadmium organic salt by reacting its oxide or inorganic salts with a long chain organic acid.

In a related aspect the present invention provides a method of forming a nanocrystal of the composition CdA, with A being S or Se. The method includes forming in a suitable solvent a solution of a cadmium organic salt by reacting, for example, its oxide or an inorganic salt with a long chain organic acid, or a compound thereof, in a form suitable for the generation of a nanocrystal. The solvent is selected from the group consisting of dioctyl ether, 1-octadecene, oleylamine and any combination thereof. The method further includes bringing the solution to a temperature selected in the range from about 20° C. to about 200° C. The method also includes adding at the temperature selected in the range from about 20° C. to about 200° C. the element A in a form suitable for the generation of a nanocrystal. Thereby the forming of a nanocrystal of the composition CdA is allowed.

The nanocrystal obtained by a method of the invention is typically homogenous.

In a further aspect the invention also relates to the use of a nanocrystal obtained by one of the above methods in the manufacture of an illuminant.

The invention will be better understood with reference to the detailed description when considered in conjunction with the accompanying drawings, in which:

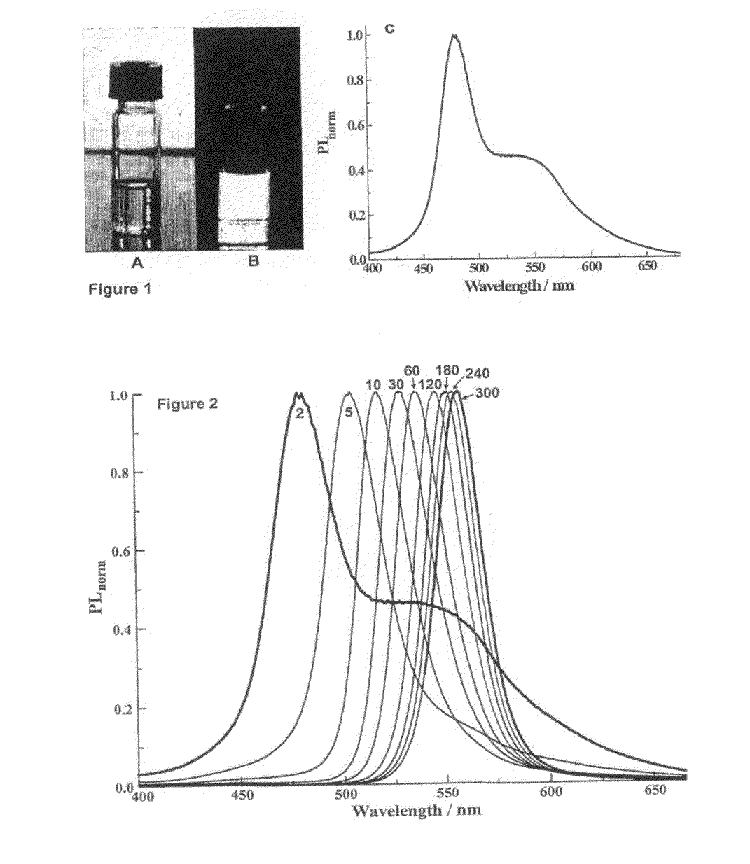

FIG. 1A shows a photograph depicting a solution of white quantum dots prepared according to the method of the invention in n-hexane solution.

FIG. 1B shows a photograph depicting the solution shown in FIG. 1A upon lightening up an excitation UV lamp in the dark.

FIG. 1C shows a photoluminescence spectrum of the solution depicted in the photographs of FIGS. 1A and 1B.

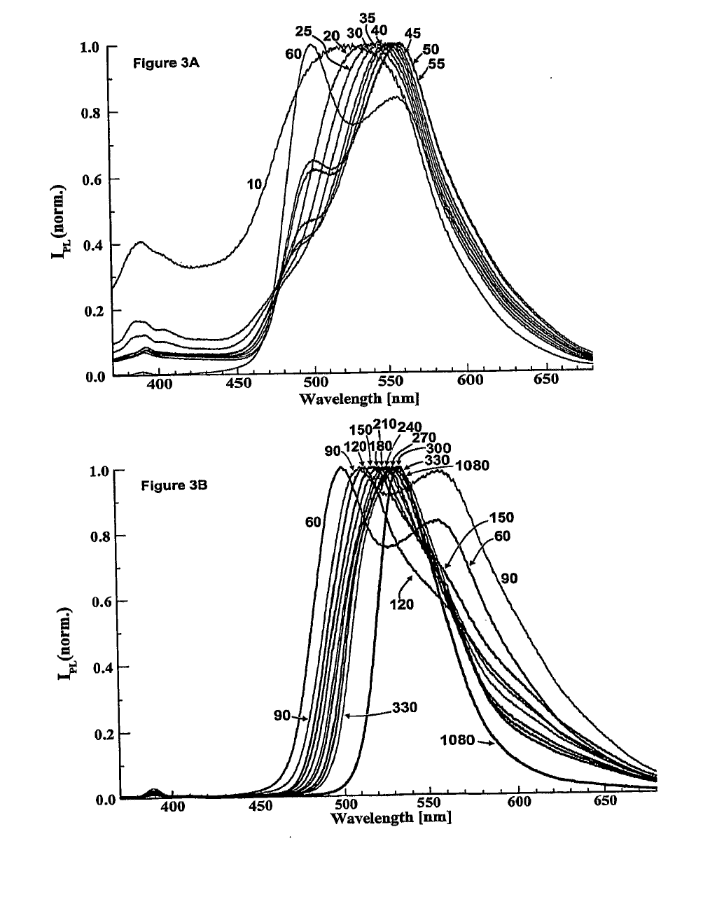

FIG. 2 depicts photoluminescence spectra of CdSe quantum dots prepared at 120° C. Quantum dots were allowed to grow and aliquots taken after the indicated periods of time (in minutes), when they were quenched with cold n-hexane.

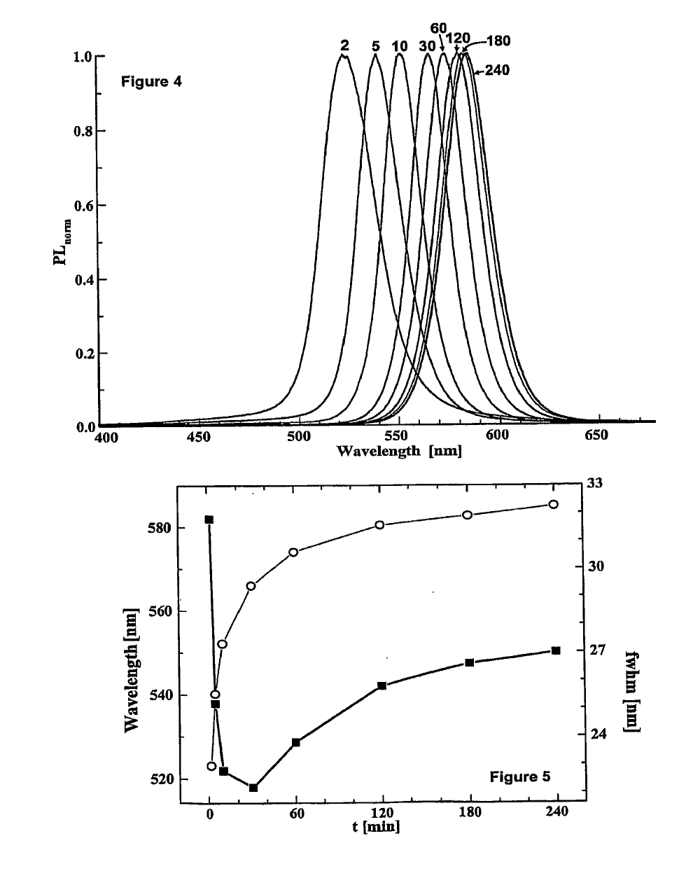

FIG. 3 depicts photoluminescence spectra of CdSe quantum dots prepared at 80° C.

FIG. 3A: Quantum dots were allowed to grow for 10 to 60 minutes (indicated numbers are time points in minutes) when aliquots were taken and quenched with cold n-hexane.

FIG. 3B: Quantum dots were allowed to grow for 60 minutes to 18 hours (indicated numbers are time points in minutes) when aliquots were taken and quenched with cold n-hexane.

FIG. 4 depicts photoluminescence spectra of CdSe quantum dots prepared at 160° C. Quantum dots were allowed to grow and aliquots taken after the indicated periods of time (in minutes), when they were quenched with cold n-hexane.

FIG. 5 depicts the Photoluminescence Wavelength (left y-axis) and Full Width at Half Maximum (right y-axis) of CdSe quantum dots recorded on aliquots taken at different stages of the reaction (x-axis) at 160° C.

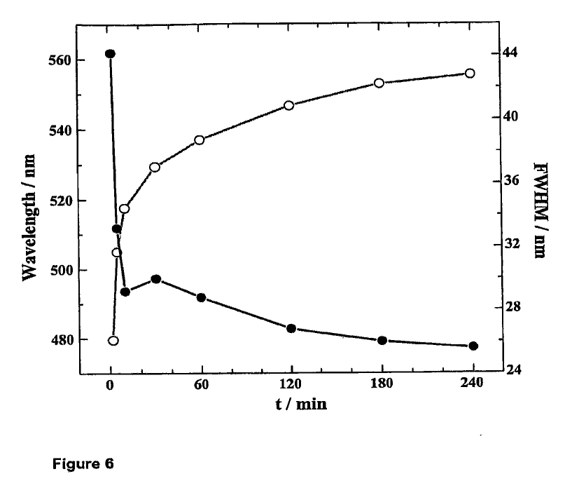

FIG. 6 depicts the Photoluminescence Wavelength (left y-axis) and Full Width at Half Maximum (right y-axis) of CdSe quantum dots recorded on aliquots taken at different stages of the reaction (x-axis) at 120° C.

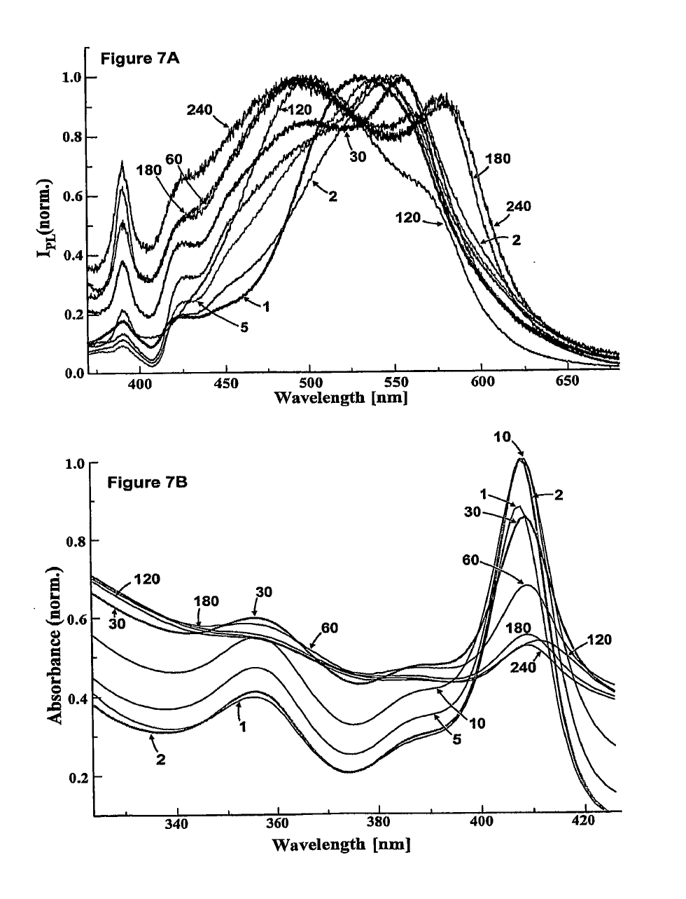

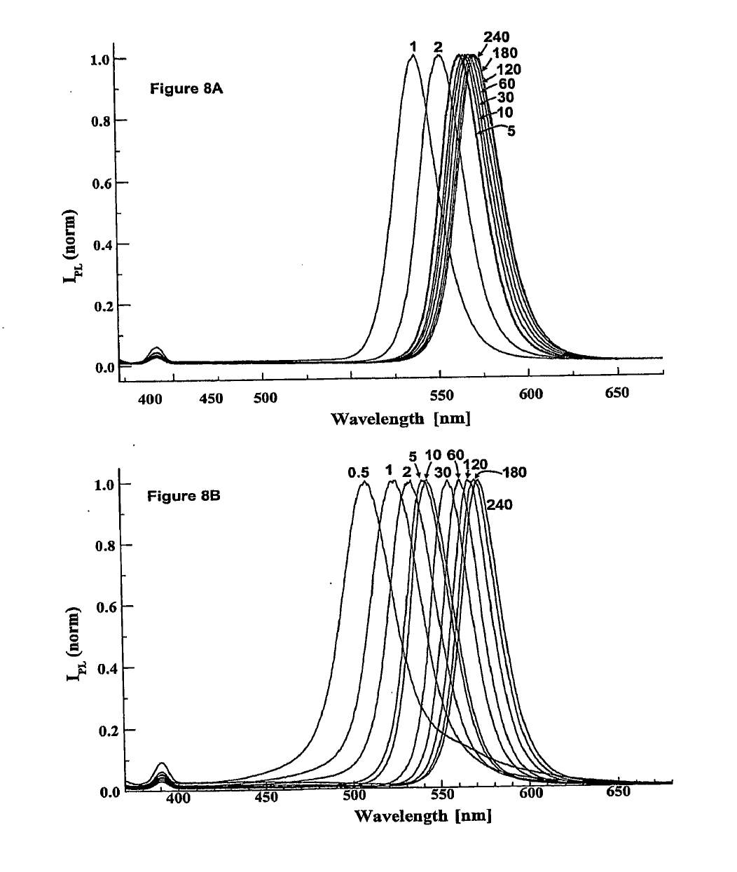

FIG. 7 depicts photoluminescence (FIG. 7A) and absorption (FIG. 7B) spectra of CdSe quantum dots prepared in tri-n-octylphosphine (TOP) at 120° C., recorded from the aliquots taken.

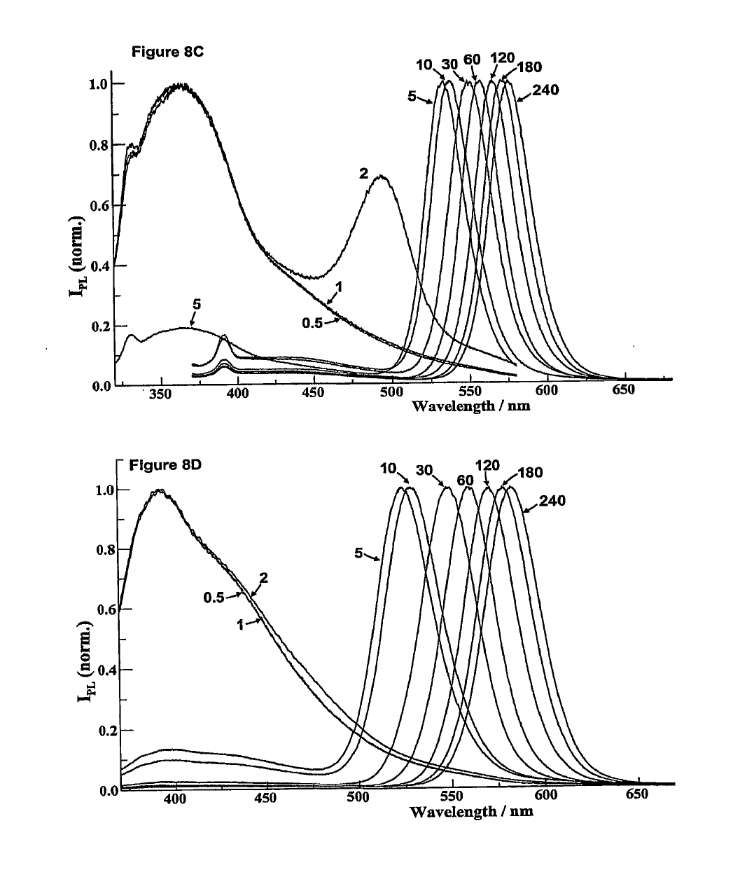

FIG. 8 depicts photoluminescence spectra of CdSe quantum dots prepared in tri-n-octylphosphine (TOP)/oleylamine (v/v, 1:1) (FIG. 8A), dioctylether (ODE) (FIG. 8B), ODE/oleylamine (v/v, 1:1) (FIG. 8C), and oleylamine (FIG. 8D) at 120° C.

As can be taken from these appended figures, high quality nanocrystals can be formed using the method of the present invention at mild reaction conditions. Fully controlled paramaters allow for the fine adjustment of desired properties of the obtained nanocrystals. As an example, a nanocrystal obtained by the method of the present invention may be used in an illuminant, an amplifier, in a biological sensor or for computation methods. When used in an illuminant, i.e. a light emitting device such as a lamp, a light emitting diode, a laser diode, a fluorophore (for instance in the detection of tumors), a TV-screen or a computer monitor, the wavelength range, including the peak of light emission, can be adjusted by selecting values for process parameters in the method of the invention. One such embodiment of the invention is a nanocrystal that emits white light. Accordingly, the present invention also relates to the use of a nanocrystal obtainable or obtained by the method of the invention. As can be taken by the illustrative figures, the respective wavelength range, including the emission peak, can be controlled by factors such as the temperature at which the element A is added, the reaction time, the solvent used, the surfactant used, and the amount of surfactant added.

Any suitable solvent may be used in the method of the present invention as long as its main component is not tri-n-octylphosphine oxide (see also below). Typically the solvent is or includes a coordinating solvent. The solvent includes an ether or an amine, such as an alkylamine or a dialkylamine. In typical embodiments the solvent is a weak coordinating solvent. It may also include non-coordinating components such as an alkane or an alkene (see below) or strong coordinating components such as tri-n-octylphosphine.

The solvent used in the method of the invention is typically a high-boiling solvent, e.g. with a boiling point above about 120° C., 150° C., 180° C. or above about 220° C. In some embodiments a combination of solvent components is selected, which has a boiling point above the highest selected temperature during the method of the invention (e.g. for dissolving cadmium or a cadmium compound). The ether or amine itself may be a high-boiling solvent. Examples of a suitable ether include, but are not limited to, dioctylether (CAS-No. 629-82-3), didecyl ether (CAS-No. 2456-28-2), diundecyl ether (CAS-No. 43146-97-0), didodecyl ether (CAS-No. 4542-57-8), 1-butoxy-dodecane (CAS-No. 7289-38-5), heptyl octyl ether (CAS-No. 32357-84-9), octyl dodecyl ether (CAS-No. 36339-51-2), and 1-propoxy-heptadecane (CAS-No. 281211-90-3). Examples of a suitable amine include, but are not limited to, 1-amino-9-octadecene (oleylamine) (CAS-No. 112-90-3), 1-amino-4-nonadecene (CAS-No. 25728-99-8), 1-amino-7-hexadecene (CAS-No. 225943-46-4), 1-amino-8-heptadecene (CAS-No. 712258-69-0, CAS-No of the pure Z-isomer: 141903-93-7), 1-amino-9-heptadecene (CAS-No. 159278-11-2, CAS-No of the Z-isomer: 906450-90-6), 1-amino-9-hexadecene (CAS-No. 40853-88-1), 1-amino-9-eicosene (CAS-No. 133805-08-0), 1-amino-9,12-octadecadiene (CAS-No. 13330-00-2), 1-amino-8,11-heptadecadiene (CAS-No. 141903-90-4), 1-amino-13-docosene (CAS-No. 26398-95-8), N-9-octadecenyl-propanediamine (CAS-No. 29533-51-5), N-10. octyl-2,7-octadienyl-amine (CAS-No. 67363-03-5), N-9-octadecen-1-yl-9-octadecen-1-amine (dioleylamine) (CAS-No. 40165-68-2), bis(2,7-octadienyl)amine (CAS-No. 31334-50-6), and N,N-Dibutyl-2,7-octadienylamine (CAS-No. 63407-62-5).

Other compounds that may be included in the solvent include, but are not limited to, an alkyl- or aryl phosphine, a phospine oxide, an alkane, or an alkene. The respective compounds may include long chain alkyl or aryl groups, such as dodecylamine, hexadecylamine, octa-decylamine, etc. It is however noted that compounds with such long chain moieties are not required in the method of the present invention. Illustrative examples of an alkene include, but are not limited to, 1-dodecene (CAS-No 112-41-4), 1-tetradecene (CAS-No 1120-36-1), 1-hexadecene (CAS No. 629-73-2), 1-heptadecene (CAS No. 6765-39-5), 1-octadecene (CAS No. 112-88-9), 1-eicosene (CAS No. 3452-07-1), 7-tetradecene (CAS-No 1037474-0), 9-hexacosene (CAS-No 71502-22-2), 1,13-tetradecadiene (CAS No21964-49-8) or 1,17-octa-decadiene (13560-93-5). Illustrative examples of an alkane are decane (CAS-No 124-18-5), undecane (CAS-No 1120-21-4), tridecane (CAS-No 629-50-5), hexadecane (CAS-No 544-76-3), octadecane (CAS-No 593-45-3), dodecane (CAS-No 112-40-3) and tetradecane (CAS-No 629-59-4). Illustrative examples of a phosphine are trioctylphosphine, tributylphosphine, tri (dodecyl) phosphine. Illustrative examples of a phosphine oxide are trioctylphosphine oxide, tris(2-ethylhexyl) phosphine oxide, and phenylbis(2,4,6-trimethylbenzoyl)-phosphine oxide. Noteworthy, the method of the present invention can however be performed in the absence of alkanes, alkenes, phosphines or phosphine oxides. Such solvents, which are continuously being used in approaches to improve the performance of the method of Bowers et al. (see above, cf. e.g. Jose, R., et al., Applied Physics Letters [2006] 89, 013115) or Japanese patent application JP 2006-143526, are generally cost intensive and thus provide an obstacle to upscaling and economic production.

In some embodiments of the method of the invention the solvent includes both an alkene and an amine. The alkene and the amine may be present in any ratio, such as for instance in the range of about 100:1 (v/v) to about 1:100 (v/v), 10:1 (v/v) to about 1:10 (v/v) or about 5:1 (v/v) about 1:5 (v/v). In some embodiments the solvent includes both an alkyl phosphine or an aryl phosphine and an amine. The phosphine and the amine may also be present in any ratio, such as for instance in the range of about 100:1 (v/v) to about 1:100 (v/v), 10:1 (v/v) to about 1:10 (v/v) or about 5:1 (v/v) about 1:5 (v/v).

The solvent is at least essentially free of tri-n-octylphosphine oxide. The term “at least essentially free of” as used herein for a solvent refers to the use of amounts of a solvent that do not significantly affect the total fluid content. This term thus includes the complete absence and the presence of traces of the solvent, for example about 0,01%, about 0,1%, about 0.5%, about 1%, about 2%, about 3%, about 4% or about 5% (in relation to the total volume of the used solvent). Accordingly the main solvent (which can also be a mixture of different solvents other than tri-n-octylphosphine oxide) in the method of the present invention, in which a solution of cadmium, or a compound thereof, is prepared, is, or is dominated and governed, by a solvent that differs from tri-n-octylphosphine oxide.

In the respective solvent (or mixture of solvents) a solution of a cadmium compound is formed. Any cadmium compound may be used that can be dissolved in the selected solvent. The cadmium compound may for example be elemental cadmium, an organic cadmium salt or an inorganic cadmium salt such as cadmium carbonate or cadmium chloride). The compound may also be cadmium oxide which by dissolving the same will be converted into a cadmium salt such as an inorganic or organic salt. Forming a solution of the cadmium compound, respectively, may in some embodiments include bringing the solvent to an elevated temperature. After dissolving cadmium or the cadmium compound, the temperature of the solution may be changed, such as reduced to a selected temperature.

In some embodiments a solution of a cadmium organic compound is formed in the solvent. The cadmium organic compound may be dispersed, typically directly, in the solvent. The cadmium organic compound may also be obtained by or having its inorganic counterparts reacting with a long chain organic acid, possibly, in the presence of the solvent. Most of inorganic cadmium compounds may be used to form soluble organic salts in the selected solvent. Examples of a suitable starting cadmium compound include, but are not limited to, cadmium oxide, cadmium carbonate (CdCO₃), cadmium nitrate (Cd(NO₃)₂), cadmium chloride (CdCl₂), dimethylcadmium (CdMe₂), cadmium acetate (Cd(Ac)₂), cadmium oleate (Cd(OA)₂) and cadmium stearate, to mentioned only a few.

The method of the invention may also include adding a surfactant. The surfactant may be added to the solvent before a solution of cadmium, or a cadmium compound, is formed, or at the same time. The surfactant may also be added to the solution of cadmium, or the cadmium compound, which has been formed in the respective solvent. Typically the surfactant is added before sulphur or selenium (see also below), or a compound thereof, are added. Any surfactant may be used. The surfactant may for instance be an organic carbonic acid (carboxylic acid), an organic phosphate, an organic phosphonic acid or a mixture thereof. Illustrative examples of suitable organic carbonic acid include, but are not limited to, stearic acid (octadecanoic acid), lauric, acid, oleic acid ([Z]-octadec-9-enoic acid), n-undecanoic acid, linoleic acid, ((Z,Z)-9,12-octadecadienoic acid), arachidonic acid ((all-Z)-5,8,11,14-eicosa-tetraenoic acid), linelaidic acid ((E,E)-9,12-octadecadienoic acid), myristoleic acid (9-tetrade-cenoic acid), palmitoleic acid (cis-9-hexadecenoic acid), myristic acid (tetradecanoic acid), palmitic acid (hexadecanoic acid) and γ-homolinolenic acid ((Z,Z,Z)-8,11,14-eicosatrienoic acid). Examples of other surfactants (an organic phosphonic acid, for example) include hexyl-phosphonic acid and tetra decylphosphonic acid. It has previously been observed that oleic acid is capable of stabilising nanocrystals and allows the usage of octadecene as a solvent (Yu, W. W., & Peng, X., Angew. Chem. Int. Ed. (2002) 41, 13, 2368-2371). In the synthesis of other nanocrystals surfactants have been shown to affect the crystal morphology of the nano crystals formed (Zhou, G, et al., Materials Lett. (2005) 59, 2706-2709). The present inventors made the surprising finding that the usage of a surfactant in combination with a suitable solvent allows mild reaction conditions (even in the absence of an inert gas atmosphere) at a high concentration (see also below).

In some embodiments a solution of an inorganic cadmium salt is formed. Upon adding an organic acid such as an organic carbonic acid (see above for examples), which is typically a long chain organic carbonic acid, to the solution of the inorganic cadmium salt (which can also be obtained by dissolving cadmium oxide, see above) an organic cadmium salt such as cadmium salt of an organic carbonic acid, may be formed. It is noted in this regard the formation of a complex mixture has been observed in the case of indium compounds (Lucey, D. W., et al., Chem. Mater. (2005) 17, 3754-3762).

In the method of the invention the solution of cadmium or the cadmium compound is brought to a temperature selected in the range from about 20° C. to about 200° C., such as about 30° C. to about 180° C., about 40° C. to about 160° C. or about 70° C. to about 160° C. The temperature may for instance be about 60° C., about 80° C., about 100° C., about 120° C. or about 160° C. At the respective temperature the element A, i.e. sulphur or selenium, is added in a form suitable for the generation of a nanocrystal. The respective element may be added in any suitable solvent such as for instance a phosphine, e.g. tri-n-octylphosphine (CAS No. 4731-53-7), tri-n-nonyl-phosphine (CAS No. 17621-06-6), tri-n-heptylphosphine (CAS No 17621-04-4), tri-n-hexylphosphine (CAS No. 4168-73-4), tri-n-butylphosphine (CAS No 998-40-3), tri-p-tolyl-phosphine (CAS No 1038-95-5), tri-1-naphthyl-phosphine (CAS No 3411-48-1) or triphenylphosphine (CAS No 603-35-0).

The reaction may be carried out for any desired period of time, ranging from milliseconds to a plurality of hours. Where desired, the reaction is carried out in an inert atmosphere, i.e. in the presence of gases that are not reactive, or at least not reactive to a detectable extent, with regard to the reagents and solvents used Examples of a reactive inert atmosphere are nitrogen or a noble gas such as argon or helium. It is however noteworthy that an inert gas atmosphere was found to be generally unnecessary.

The method of the invention can conveniently be used to prepare nanocrystals, including white light emitting quantum dots, at mild reaction conditions. Compared to known methods of forming quantum dots the present method allows the preparation of (colour) quantum dots at a high concentration. Compared to the method disclosed by Bowers et al. (2005, supra), for example, the present method has for instance been found to result in the formation of a preparation of quantum dots with a 5˜10 times higher concentration.

The method of the present invention is furthermore particularly suitable for forming conventional quantum dots with relatively narrow emission peaks (fwhm˜23 nm). Under the mild reaction conditions it is plain sailing to tune the wavelength of the emission peak in fine increment (Δλ=1 nm). By selecting a particular reaction temperature and a particular reaction time (see e.g. FIG. 5, FIG. 6 and FIG. 8) the emission wavelength of a nanocrystal formed can be adjusted as desired. Furthermore, swift injection has been found not necessary for this preparation, and a new mixture of solvent enabled the production of quantum dots with 5-10 times of higher concentration thus lowering the purification effort and cost. All these provide a chance for mass production of quantum dots and their derivatized products at low cost.

The method of the invention may further include nanocrystal post-processing. Although the nanocrystals obtained by the method of the invention are generally at least essentially or at least almost monodisperse, if desired a step may be performed to narrow the size-distribution (for example as a precaution or a safety-measure). Such techniques, e.g. size-selective precipitation, are well known to those skilled in the art. The surface of the nanocrystal may also be altered, for instance coated.

In some embodiments the nanocrystal (or the plurality thereof) formed by the method of the invention is coupled to a molecule with binding affinity for a selected target molecule, such as a microorganism, a virus particle, a peptide, a peptoid, a protein, a nucleic acid, a peptide, an oligosaccharide, a polysaccharide, an inorganic molecule, a synthetic polymer, a small organic molecule or a drug.

The term “nucleic acid molecule” as used herein refers to any nucleic acid in any possible configuration, such as single stranded, double stranded or a combination thereof. Nucleic acids include for instance DNA molecules (e.g., cDNA or genomic DNA), RNA molecules (e.g., mRNA), analogues of the DNA or RNA generated using nucleotide analogues or using nucleic acid chemistry, locked nucleic acid molecules (LNA), and protein nucleic acids molecules (PNA). DNA or RNA may be of genomic or synthetic origin and may be single or double stranded. In the present method of the invention typically, but not necessarily, an RNA or a DNA molecule will be used. Such nucleic acid can be e.g. mRNA, cRNA, synthetic RNA, genomic DNA, cDNA synthetic DNA, a copolymer of DNA and RNA, oligonucleotides, etc. A respective nucleic acid may furthermore contain non-natural nucleotide analogues and/or be linked to an affinity tag or a label. In some embodiments the nucleic acid molecule may be isolated, enriched, or purified. The nucleic acid molecule may for instance be isolated from a natural source by cDNA cloning or by subtractive hybridization. The natural source may be mammalian, such as human, blood, semen, or tissue. The nucleic acid may also be synthesized, e.g. by the triester method or by using an automated DNA synthesizer.

Many nucleotide analogues are known and can be used in nucleic acids and oligonucleotides used in the methods of the invention. A nucleotide analogue is a nucleotide containing a modification at for instance the base, sugar, or phosphate moieties. Modifications at the base moiety include natural and synthetic modifications of A, C, Q and T/U, different purine or pyrimidine bases, such as uracil-5-yl, hypoxanthin-9-yl, and 2-aminoadenin-9-yl, as well as non-purine or non-pyrimidine nucleotide bases. Other nucleotide analogues serve as universal bases. Universal bases include 3-nitropyrrole and 5-nitroindole. Universal bases are able to form a base pair with any other base. Base modifications often can be combined with for example a sugar modification, such as for instance 2′-O-methoxyethyl, e.g. to achieve unique properties such as increased duplex stability.

A peptide may be of synthetic origin or isolated from a natural source by methods well-known in the art. The natural source may be mammalian, such as human, blood, semen, or tissue. A peptide, including a polypeptide may for instance be synthesized using an automated polypeptide synthesizer. Illustrative examples of polypeptides are an antibody, a fragment thereof and a proteinaceous binding molecule with antibody-like functions. Examples of (recombinant) antibody fragments are Fab fragments, Fv fragments, single-chain Fv fragments (scFv), diabodies, triabodies (Iliades, P., et al., FEBS Lett (1997) 409, 437-441), decabodies (Stone, E., et al., Journal of Immunological Methods (2007) 318, 88-94) and other domain antibodies (Holt, L. J., et al., Trends Biotechnol. (2003), 21, 11, 484-490). An example of a proteinaceous binding molecule with antibody-like functions is a mutein based on a polypeptide of the lipocalin family (WO 03/029462, Beste et al., Proc. Natl. Acad. Sci. U.S.A. (1999) 96, 1898-1903). Lipocnlins, such as the bilin binding protein, the human neutrophil gelatinase-associated lipocalin, human Apolipoprotein D or glycodelin, posses natural ligand-binding sites that can be modified so that they bind to selected small protein regions known as haptens. Examples of other proteinaceous binding molecules are the so-called glubodies (see e.g. internation patent application WO 96/23879), proteins based on the ankyrin scaffold (Mosavi, L. K., et al., Protein Science (2004) 13, 6, 1435-1448) or crystalline scaffold (e.g. internation patent application WO 01/04144) the proteins described in Skerra, J. Mol. Recognit. (2000) 13, 167-187, AdNectins, tetranectins and avimers. Avimers contain so called A-domains that occur as strings of multiple domains in several cell surface receptors (Silverman, J., et al., Nature Biotechnology (2005) 23, 1556-1561). Adnectins, derived from a domain of human fibronectin, contain three loops that can be engineered for immunoglobulin-like binding to targets (Gill, D. S. & Damle, N. K., Current Opinion in Biotechnology (2006) 17, 653-658). Tetranectins, derived from the respective human homotrimeric protein, likewise contain loop regions in a C-type lectin domain that can be engineered for desired binding (ibid.). Peptoids, which can act as protein ligands, are oligo(N-alkyl) glycines that differ from peptides in that the side chain is connected to the amide nitrogen rather than the α carbon atom. Peptoids are typically resistant to proteases and other modifying enzymes and can have a much higher cell permeability than peptides (see e.g. Kwon, Y.-U., and Kodadek, T., J. Am. Chem. Soc. (2007) 129, 1508-1509).

As a further illustrative example, a linking moiety such as an affinity tag may be used to immobilise the respective molecule. Such a linking moiety may be a molecule, e.g. a hydrocarbon-based (including polymeric) molecule that includes nitrogen-, phosphorus-, sulphur-, carben-, halogen- or pseudohalogen groups, or a portion thereof. As an illustrative example, the selected surface may include, for instance be coated with, a brush-like polymer, for example with short side chains. The immobilisation surface may also include a polymer that includes a brush-like structure, for example by way of grafting. It may for example include functional groups that allow for the covalent attachment of a biomolecule, for example a molecule such as a protein, a nucleic acid molecule, a polysaccharide or any combination thereof. Examples of a respective linking moietyfunctional group include, but are not limited to, an amino group, an aldehyde group, a thiol group, a carboxy group, an ester, an anhydride, a sulphonate, a sulphonate ester, an imido ester, a silyl halide, an epoxide, an aziridine, a phosphoramidite and a diazoalkane.

Examples of an affinity tag include, but are not limited to biotin, dinitrophenol or digoxigenin, oligohistidine, polyhistidine, an immunoglobulin domain, maltose-binding protein, glutathione-5-transferase (GST), calmodulin binding peptide (CBP), FLAG′-peptide, the T7 epitope (Ala-Ser-Met-Thr-Gly-Gly-Gln-Gln-Met-Gly), maltose binding protein (MBP), the HSV epitope of the sequence Gln-Pro-Glu-Leu-Ala-Pro-Glu-Asp-Pro-Glu-Asp of herpes simplex virus glycoprotein D, the hemagglutinin (HA) epitope of the sequence Tyr-Pro-Tyr-Asp-Val-Pro-Asp-Tyr-Ala, the “myc” epitope of the transcription factor c-myc of the sequence Glu-Gln-Lys-Leu-Ile-Ser-Glu-Glu-Asp-Leu, or an oligonucleotide tag. Such an oligonucleotide tag may for instance be used to hybridise to an immobilised oligonucleotide with a complementary sequence. A further example of a linking moiety is an antibody, a fragment thereof or a proteinaceous binding molecule with antibody-like functions (see also above).

A further example of linking moiety is a cucurbituril or a moiety capable of forming a complex with a cucurbituril. A cucurbituril is a macrocyclic compound that includes glycoluril units, typically self-assembled from an acid catalyzed condensation reaction of glycoluril and formaldehyde. A cucurbit[n]uril, (CB[n]), that includes n glycoluril units, typically has two portals with polar ureido carbonyl groups. Via these ureido carbonyl groups cucurbiturils can bind ions and molecules of interest. As an illustrative example cucurbit[7]uril (CB[7]) can form a strong complex with ferrocenemethylammonium or adamantylammonium ions. Either the cucurbit[7]uril or e.g. ferrocenemethylammonium may be attached to a biomolecule, while the remaining binding partner (e.g. ferrocenemethylammonium or cucurbit[7]uril respectively) can be bound to a selected surface. Contacting the biomolecule with the surface will then lead to an immobilisation of the biomolecule. Functionalised CB[7] units bound to a gold surface via alkanethiolates have for instance been shown to cause an immobilisation of a protein carrying a ferrocenemethylammonium unit (Hwang, I., et al., J. Am. Chem. Soc. (2007) 129, 4170-4171).

Further examples of a linking moiety include, but are not limited to an oligosaccharide, an oligopeptide, biotin, dinitrophenol, digoxigenin and a metal chelator (cf. also below). As an illustrative example, a respective metal chelator, such as ethylenediamine, ethylenediaminetetraacetic acid (EDTA), ethylene glycol tetraacetic acid (EGTA), diethylene-triaminepentaacetic acid (DTPA), N,N-bis(carboxymethyl)glycine (also called nitrilotriacetic acid, NTA), 1,2-bis(o-aminophenoxy)ethane-N,N,N′,N′-tetraacetic acid (BAPTA), 2,3-dimer-capto-1-propanol (dimercaprol), porphine or heme may be used in cases where the target molecule is a metal ion. As an example, EDTA forms a complex with most monovalent, divalent, trivalent and tetravalent metal ions, such as e.g. silver (Ag⁺), calcium (Ca²⁺), manganese (Mn²⁺), copper (Cu²⁺), iron (Fe²⁺), cobalt (Co³⁺) and zirconium (Zr⁴⁺), while BAPTA is specific for Ca²⁺. In some embodiments a respective metal chelator in a complex with a respective metal ion or metal ions defines the linking moiety. Such a complex is for example a receptor molecule for a peptide of a defined sequence, which may also be included in a protein. As an illustrative example, a standard method used in the art is the formation of a complex between an oligohistidine tag and copper (Cu²⁺), nickel (Ni²⁺), cobalt (Co²⁺), or zink (Zn²⁺) ions, which are presented by means of the chelator nitrilotriacetic acid (NTA).

Avidin or streptavidin may for instance be employed to immobilise a biotinylated nucleic acid, or a biotin containing monolayer of gold may be employed (Shumaker-Parry, J. S., et al., Anal. Chem. (2004) 76, 918). As yet another illustrative example, the biomolecule may be locally deposited, e.g. by scanning electrochemical microscopy, for instance via pyrrole-oligonucleotide patterns (e.g. Fortin, E., et al., Electroanalysis (2005) 17, 495). In other embodiments, in particular where the biomolecule is a nucleic acid, the biomolecule may be directly synthesised on the surface of the immobilisation unit, for example using photoactivation and deactivation. As an illustrative example, the synthesis of nucleic acids or oligonucleotides on selected surface areas (so called “solid phase” synthesis) may be carried out using electrochemical reactions using electrodes. An electrochemical deblocking step as described by Egeland & Southern (Nucleic Acids Research (2005) 33, 14, e125) may for instance be employed for this purpose. A suitable electrochemical synthesis has also been disclosed in US patent application US 2006/0275927. In some embodiments light-directed synthesis of a biomolecule, in particular of a nucleic acid molecule, including UV-linking or light dependent 5′-deprotection, may be carried out.

The molecule that has a binding affinity for a selected target molecule may be immobilised on the nanocrystals by any means. As an illustrative example, an oligo- or polypeptide, including a respective moiety, may be covalently linked to the surface of nanocrystals via a thio-ether-bond, for example by using ω functionalized thiols. Any suitable molecule that is capable of linking a nanocrystal of the invention to a molecule having a selected binding affinity may be used to immobilise the same on a nanocrystal. For instance a (bifunctional) linking agent such as ethyl-3-dimethylaminocarbodiimide, N-(3-aminopropyl) 3-mercapto-benzamide, 3-aminopropyl-trimethoxysilane, 3-mercaptopropyl-trimethoxysilane, 3-(trimethoxysilyl) propyl-maleimide, or 3-(trimethoxysilyl) propyl-hydrazide may be used. Prior to reaction with the linking agent, the surface of the nanocrystals can be modified, for example by treatment with glacial mercaptoacetic acid, in order to generate free mercaptoacetic groups which can then employed for covalently coupling with an analyte binding partner via linking agents.

### Exemplary Embodiments of the Invention

Exemplary embodiments of methods according to the invention as well as reactants and further processes that may be used are shown in the appending figures.

### General

A colloidal wet chemistry approach was universally taken in the following examples. Dioctyl ether (99%), tri-n-octyl phosphine (TOP, 90%), 1-octadecene (ODE, 90%), oleylamine (70%), oleic acid (90%), and selenium (100 mesh, 99.999%) were all products of Sigma-Aldrich Chemie GmbH, Germany; Cadmium oxide (99.999%) was a product of Strem Chemicals, USA.

Mostly quantum dots with narrow emission peaks were prepared in a non-water solvent with high boiling point (TOPO, TOP, ODE, dioctyl ether, oleylamine, or a mixture solvent from two or more of these solvents). The capping agents used to passivate the highly energetic surface of the quantum dots were TOPO, oleic acid, etc. The as-prepared quantum dots can be dispersed in non-water solvents, such as hexane, chloroform, and toluene. Their water-soluble counterparts may be obtained via a surface ligand exchange process, and the complexity depends on the stability of the quantum dots.

The methods of the following examples use an exemplary selected solvent or solvent combination, do not require long chain alkylamine compounds as starting material and are performed at low reaction temperatures. The crude products were in all cases found to be of a 5˜10 times higher concentration than previously achieved. The examples include detailed comparisons, which include the quantum dots preparation at different reaction temperatures, in different solvents, as well as with different ratio of cadmium oxide to the oleic acid applied. Further, polymer/quantum dots hybrid materials fabrications from these quantum dots are presented.

### EXAMPLE 1

### Preparation of White-Emitting CdSe Quantum Dots at 120° C.

0.128 g cadmium oxide (CdO, 1.0 mmol) was put together with 1.28 ml of oleic acid (4.0 mmol) and 12 mL of dioctyl ether in a 50 mL reaction flask, equipped with thermometer sensor. After degassing the reaction mixture was heated to 250° C. (all temperature numbers in this document refer to centigrade). As soon as a clear and colorless solution formed, the solution was cooled down to 120° C., 1.2 ml of 1M selenium/TOP solution, prepared by dissolving 3.95 g of 100 mesh selenium in 50 mL of TOP, was injected into the reaction flask. After 2 minutes of reaction, the heater was removed and the reaction mixture was poured into cold n-hexane immediately. Mixing methanol with same volume of the n-hexane solution obtained, a phase separation will occur. Discarding the bottom layer (consisting of n-hexane, methanol, dioctyl ether, TOP, as well as some unreacted oleic acid). Washing the mixture once more with n-hexane/methanol mixture (v/v, 1:1), the white quantum dots can be precipitated with methanol (if the volume of n-hexane is big, phase separation may appear again, and the volume of the top layer will be largely reduced. Discarding the bottom layer and continue with methanol for the precipitation process) or acetone (using acetone may lose part of the product due to the noticeable solubility of the quantum dots in the mixture of n-hexane and acetone), and collected by centrifugation. The obtained pellet can be dispersed in n-hexane, toluene or chloroform for further application or characterization.

FIG. 1A shows a photograph depicting a solution of white quantum dots prepared according to the method of the invention in n-hexane solution. In room light, in the absence of an excitation light, this solution appeared in yellow-green color. FIG. 1B shows a photograph depicting the solution shown in FIG. 1A upon lightening up an excitation UV lamp in the dark. A bright white light was emitted. The reflected image of the solution at the bottom of the photo (immediately below the vial) is of a slightly blue mark. FIG. 1C shows a photoluminescence spectrum of the solution depicted in the photographs of FIGS. 1A and 1B. The blue feature revealed in the reflection in FIG. 1B also appears in this spectrum. By increasing the concentration of the white quantum dots, this blue emitting character can be suppressed due to the FRET effect and purer and brighter white light can be obtained.

The quantum dots emitting such a white light may possess a narrow size distribution, but possibly also a distribution profile with several peaks (centers on different sizes) which resembles the case of mixing several narrow dispersed quantum dots together (according to the common understandings). A way to test this out is to let the prepared white quantum dots further grow at 120° C., and take aliquots at different reaction intervals and quench them with cold n-hexane. The experiments were conducted and the photoluminescence spectra were recorded from the aliquots samples. In FIG. 2 a series of the spectra were put together for a comparison.

FIG. 2 depicts photoluminescence spectra of CdSe quantum dots prepared at 120° C. As can be seen, at the 5th minute the shoulder peak at longer wavelengths disappeared. With time the peak turned narrower and narrower, and the shape remained almost unchanged after 180 minutes of reaction, with the position of the emission peak shifting to longer wavelengths. The shift of PL spectra of the quantum dots with time at 120° C. suggests that at about the 2nd minute the quantum dots most probably have the narrowest size distribution. These data further show that the emission peak can be tuned in very small increments, especially after 30 minutes of reaction. Thus it was quantum dots with narrow size distribution emit a mixture of light, i.e. white light. Without the intent to be bound by theory, a possible explanation might be that at the second minute quantum dots with a “magic size” (thermodynamically stable) formed. These quantum dots, however, may have had a relatively irregular surface by which different surface states co-existed, leading to emission of different colors, and thereby a collective white light emission. When heat was continuously supplied, these quantum dots may then have grown further. The previous active surface states may thereby have been passivated and thus lost some of the emission features.

### EXAMPLES 2 & 3

### Preparation of CdSe at Other Temperatures

Two more examples are given to show the preparation of such CdSe quantum dots at different temperature. The first one was to conduct the reaction at 80° C., i.e., injecting the 1.2 mL of TOP/Se solution into the reaction flask at 80° C. after the formation of a clear solution from the mixture of cadmium oxide (0.128 g, 1.0 mmol), oleic acid (1.28 mL, 4.0 mmol) and dioctyl ether (12 mL). Again aliquots of the reaction mixture were taken at certain intervals and injected into cold n-hexane.

FIG. 3 depicts photoluminescence spectra of CdSe quantum dots prepared at 80° C. Spectra depicted in FIG. 3A show quantum dots prepared with reaction times from 10 to 60 minutes. Spectra depicted in FIG. 3B show quantum dots prepared with reaction times from 60 minutes to 18 hours.

In FIG. 3A, depicting the change of the photoluminescence spectra of quantum dots in the first hour of reaction, a wide emission with a plateau at the top is visible at the 10^{th} minute. With increasing time the plateau shifted to longer wavelength emission and the widths of the emission peak became gradually narrower. After the 35^{th} minute a shoulder peak appeared at shorter wavelength. This peak grew in intensity and the entire curve showed a slight blue-shift (up to 60^{th} min). This phenomenon apparently does not appear to match the assumption of a continuous growth of quantum dots, if the photoluminescence emissions at longer wavelength in this case were originally due to a larger quantum dot size. A possible explanation would be that at these reaction stages the particles may have been in a very small magic size (same as the case before the 2^{nd} minute in the case of 120° C.). As shown in the spectra, their intrinsic emission was at ˜400 nm. The emissions at longer wavelengths may have been the consequence of extra surface states, and possibly, aggregates from loosely packed small quantum dots, and the red-shift up to the 55^{th} minute may have been due to the increased number of the surface states with time. Starting from 35 minutes, some of these quantum dots may have formed their counterparts with the next larger magic size, and the number of surface states may have decreased gradually (a crystallization process). From the 60^{th} minute this process would then be even more pronounced (cf. FIG. 3B). After a reaction period of 18 hrs, a symmetric emission peak centered at λ=538 nm (green light) was achieved, indicating an annealed surface with less surface states. Those quantum dots, up to the 90 minute, show a mixed emission covered Red-Green-Blue wavelength which is close to a white light emission.

FIG. 4 depicts photoluminescence spectra of CdSe quantum dots prepared at 160° C. All other parameters (starting materials, stoichiometric ratio, pretreatment, and etc.) were identical to the example depicted in FIG. 3. The reaction at 160° C. was remarkably faster. Even at the 2^{nd} minute a symmetric photoluminescence emission peak was visible. With time the emission peak monotonously shifted to the longer wavelengths. The absence of a shoulder peak from the 2^{nd} minute (before that it was not studied) indicated that at this reaction temperature, surface states, which are believed as the cause of the shoulder peaks at the side of longer wavelengths, seemed to disappear much faster than the case for 120° C. and 80° C. The same situation is seen if one compares the case between 120° C. and 80° C. If one takes the approximation in the reaction rate calculation (for a first-order reaction without apparent heat absorption or release the reaction rate will be doubled with an increase of 10 degree in temperature), the reaction period corresponding to the 2^{nd} minute for the reaction at 120° C. will be the 32^{nd} minute for reaction at 80° C. and the ˜8^{th} second at 160° C. Based on these observations and estimations, injection temperatures convenient for white quantum dots preparation should be lower than 160° C.; however, if single colored quantum dots with narrow emission are preferred, an injection and reaction temperature of 160° C., and possibly above, would be a better choice.

### The Growth Path of CdSe Quantum Dots

FIG. 5 depicts a plot of the wavelength against the full widths at half maximums (FWHM) for the photoluminescence spectra, recorded on the aliquots taken at different stages of the reaction at 160° C.

As can be taken from FIG. 5, the photoluminescence wavelength can be tuned from 523 nm to 585 nm (or even longer, subject to a longer reaction time—e.g., at 240th min where λ=585 nm, a slight slope exists), which almost covers the full spectrum of green (520-565 nm) and yellow light (565-590 nm). For quantum dots emitting light with shorter (e.g., blue light) or much longer (e.g. red light) wavelength, tuning would be difficult with the specified reaction condition.

A further observation is that the red-shift of the PL peak (growth of quantum dots) in all cases takes place faster at the beginning, and the shift rate decreases gradually with the reaction time. The reason is that with time the concentration of monomers used for the growth of quantum dots is reduced. Further, even if the reaction rate is constant (i.e., produces same volume, ΔV, of products in a certain reaction period, ignoring the deficiency of the reactant materials), the rate of increase of the particle diameter (ΔD) decreases when the particles grow larger

$$( Δ D = \frac{6 Δ V}{{D}_{1}^{2} + {D}_{1} {D}_{2} + {D}_{2}^{2}} ) .$$

Since the increase in diameter roughly correlates with the increase in emission wavelength, a smaller change in the rate of increase of the emission wavelength with time is reasonable. Furthermore FIG. 5 shows that at the 30^{th} minute the narrowest emission peak (FWHM=22 nm) centered at λ=566 nm was obtained, indicating rather monodispersed CdSe quantum dots. The FWHM decreases at the beginning of the reaction (FWHM: 32 (2)→25 (5)→23 (10)→22 (30) nm. The number in the bracket behind the FWHM denotes the minute when the aliquots were taken out for the measurement), but starts to rise after a reaction of 30 minutes (FWHM: 22 (30)→24 (60)→26 (120)→27 (180)→27 (240)). This suggests that at this reaction temperature the quantum dot particles first experience a “focusing” process (smaller quantum dots were dissolved to provide materials for the growth of the larger ones) which leads to a better monodispersity. After the reaction reaches the stage when all the quantum dots possess much similar size (at ˜30 min), Ostwald Ripening came into play (Nucleation→Focusing→Oswald Ripening process). In this case the materials for the further growth of some quantum dots came from dissolving other quantum dots of similar size, and a strong competition led to rather insufficient materials supply. With such an insufficient materials supply it is impossible for all the quantum dots to grow at the same time, and the size distribution broadens to some extent. The emission peak, however, can still be as narrow as fwhm ˜27 nm, even if the reaction is kept running for another 3 and half hours.

For reactions at lower temperatures, however, the Nucleation→Focusing→Oswald Ripening process is not as prominent. A respective example is shown in FIG. 6, depicting a plot of the wavelength against the FWHM for the photoluminescence spectra recorded on aliquots taken at different stages of the reaction at 120° C.

FIG. 6 depicts the dependency of the Photoluminescence Wavelength and Full Width at Half Maximum of CdSe quantum dots prepared at 120° C. In comparison to the reaction at 160° C., the tunable range of the wavelength of the photoluminescence peak is larger (78>62 nm) and the emissions are located at shorter wavelengths (479-557 nm). This is mainly due to the smaller reaction rate at lower temperature. The evolution of the full widths at half maximum for the PL peak seems to suggest that only the focusing process is present while the Ostwald Ripening phenomenon does not exist at lower temperature; however, if a very approximate estimation is taken by assuming the reaction rate doubles when the reaction temperature is increased by 10° C. (dynamic model for the first order reaction), a difference of 40° C. renders a 16-fold faster rate for reaction at higher temperature. In this case, for reaction at 120° C. the Ostwald Ripening may appear, according to the case at 160° C., after a reaction time of 16×30 min (8 hrs). This is proven in another separate preparation at the same conditions.

### Preparation of Quantum Dots in Different Solvents

Besides dioctyl ether, TOP, 1-octadecene (ODE), oleylamine, TOP/oleylamine, and ODE/oleylamine have also been used as solvent for the preparation of CdA quantum dots, respectively. All are liquid at room temperature with ODE being the most commercially favorable choice (18.56 S$/liter for 100 L).

### EXAMPLE 4

### Comparison Using TOP as Solvent

With ti-n-octylphosphine (TOP) as the solvent, a slight modification was applied in the preparation. Instead of adding the solvent at the starting point of the reaction, cadmium oleate was first prepared by reacting cadmium oxide with oleic acid alone, before the addition of the reaction solvent. The protocol of the reaction is as follows:

0:128 g cadmium oxide (1.0 mmol) was mixed with 1.28 ml oleic acid (4.0 mmol) in a 50 mL 3-neck reaction flask equipped with a thermometer sensor. After degassing the mixture was heated to 250° C. while stirring, until the dark-brown solid was completely dissolved and a lightly colored clear solution formed. Injecting 12 ml of TOP into the reaction flask and set the temperature to 120° C. At 120° C., 1.2 ml 1M TOP/Se solution was injected. Aliquots were then taken from the reaction mixtures at different reaction intervals and quenched with cold toluene.

FIG. 7 depicts photoluminescence (FIG. 7A) and absorption (FIG. 7B) spectra of CdSe quantum dots prepared in TOP at 120° C., recorded from the aliquots taken. As can be taken from FIG. 7A, the emission peak is broadening with time. This seems to be an advantage for the preparation of white quantum dots (i.e., covers R-G-B color emission); however, the white emitting light in this case was relatively weak (low quantum yield). Absorption spectra in FIG. 7B demonstrate that after a reaction period of 30 minutes the absorption peaks are gradually flattened. This suggests the gradual loss of the quantum confinement, which is in agreement with the decrease in the quantum yield (shown as weaker emitting light). With low performance with higher costs TOP is not a good candidate for the preparation of white quantum dots.

### EXAMPLES 5-8

### TOP/oleylamine (v/v, 1:1), ODE, ODE/oleylamine (v/v, 1:1), and Oleylamine as Solvent

FIG. 8 depicts photoluminescence spectra of CdSe quantum dots prepared in TOP/Oleylamine (v/v, 1:1) (FIG. 8A); ODE (FIG. 8B); ODE/Oleylamine (v/v, 1:1) (FIG. 8C); and Oleylamine (FIG. 8D) at 120° C. In the case of using TOP/oleylamine or ODE as reaction medium (the solvent) and keeping the reaction temperature at 120° C., symmetric emission peaks were observed even after a reaction time of less than 60 s. In order to obtain the magic size quantum dots which emit white light, one can either quench the reaction before 30 s (based on FIG. 8b) or carrying out the reaction at a lower temperature, e.g. 80-100° C. The two reactions at 120° C.; however, are quite good for the single color quantum dots preparation.

If ODE/oleylamine or oleylamine alone is used as reaction solvent, the reaction rate at the initial state is much slower. Even after 2 minutes of reaction the quantum dots generated still possess a wide emission peak centered at 360-390 nm. White quantum dots, in this case, could be obtained by quenching the reaction mixture between 2 and 5 minutes. Depending on the time-point of the quenching, one may get cool-white, white or warm white emission light.

Noteworthy, when ODE/oleylamine (v/v: 1:1) or oleylamine were used as the solvent, a phase separation occurred after the product was stored for a while. The quantum dots stayed at the bottom layer with a concentration 5˜10 times higher than the original concentration. In contrast thereto, most of the solvents and unreacted substances remained in the upper layer. This, on one hand, very much simplified the purification; on the other hand, the upper layer can be further used for the preparation of the next batches of the same product. Both will lead to a lower production cost

### Preparation of CdSe Quantum Dots with Different Cd/Oleic Acid Ratio

A change in the ratio between cadmium oxide and oleic acid also affects the parameters of quantum dots. The stoichiometric ratio between CdO and oleic acid is 1:2 for the preparation of cadmium oleate, one of the key components for the formation of CdSe quantum dots. Considering the purity grade (90%) of oleic acid, this minimum ratio would be 1:2.3. In order to get monodispersed quantum dots, some free ligands (oleic acid in this case) should exist when the reaction starts. A few tests indicated that for including the oleic acid at the beginning of reaction, the minimum amount of oleic acid should be 3 times of that of cadmium oxide. An increase of the oleic acid which corresponds to a higher ligand concentration, results in the quantum dots obtained at the same reaction period getting smaller. If the ratio between oleic acid and cadmium oxide is larger than 7, the quantum yield drops dramatically. At a ratio of 3˜4, high quality quantum dots can be prepared.

### Preparation of Polymer/Quantum Dots Hybrid Films

The as-prepared (crude) quantum dots were first washed with the protocol below, which is a modification of the procedure used in the art:

1 ml of crude CdSe quantum dots was dispersed in 4 ml of toluene in a 15-ml centrifugation tube. 8 ml of methanol was then added into the tube. After vortexing and centrifugation, oil-like residue appeared at the bottom of the tube. The residue was dispersed in 4 ml toluene again and followed by another 8 ml of methanol. Solid materials were obtained after another vortexing and centrifugation. The solid was dispersed in a prepared polymer (conventional polystyrene or photoconductive polyvinylcarbazole) toluene solution with desired concentrations. The obtained solution was vortexed to enable a sufficient mixing of the quantum dots with polymer chains. Thin films were then fabricated from the solution by casting or spin-coating onto different substrates (metal coated optical glass slides, fused silica slides, quartz crystal sensors, silicon wafers, and etc.) for different application purposes.

The listing or discussion of a previously published document in this specification should not necessarily be taken as an acknowledgement that the document is part of the state of the art or is common general knowledge. All documents listed are hereby incorporated herein by reference in their entirety for all purposes as if each individual document were specifically and individually indicated to be incorporated by reference.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

The invention illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognised that various modifications are possible within the scope of the invention claimed. Additional objects, advantages, and features of this invention will become apparent to those skilled in the art upon examination of the foregoing examples and the appended claims. Thus, it should be understood that although the present invention is specifically disclosed by exemplary embodiments and optional features, modification and variation of the inventions embodied therein herein disclosed may be resorted to by those skilled in the art, and that such modifications and variations are considered to be within the scope of this invention. In addition, where features or aspects of the invention are described in terms of Markush groups, those skilled in the art will recognise that the invention is also thereby described in terms of any individual member or subgroup of members of the Markush group.

1.-36. (canceled)

37. A method of forming a nanocrystal of the composition CdA, wherein A is S or Se, the method comprising:
(a) forming in a suitable solvent a solution of cadmium, or a compound thereof, in a form suitable for the generation of a nanocrystal at a temperature selected in the range from about 100 to 250° C., wherein said solvent comprises a compound selected from an ether and an amine, and wherein the solvent is at least essentially free of tri-n-octylphosphine oxide, wherein the amount of tri-n-octylphosphine oxide is less than 5% v/v
(b) bringing the solution to a reaction temperature selected in the range from about 40° C. to about 120° C.,
(c) adding at the reaction temperature selected in the range from about 40° C. to about 120° C. the element A in a form suitable for the generation of a nanocrystal, thereby allowing the forming of a nanocrystal of the composition CdA.

38. The method of claim 37, wherein the solvent comprises at least one of a dialkylether, an alkylamine and a dialkylamine.

39. The method of claim 37, wherein the solvent is a high-boiling solvent.

40. The method of claim 37, wherein the solvent comprises at least one of dioctylether, didecyl ether, diundecyl ether, didodecyl ether, 1-butoxy-dode-cane, heptyl octyl ether, octyl dodecyl ether, 1-propoxy-heptadecane, 1-amino-9-octa-decene (oleylamine), 1-amino-4-nonadecene, 1-amino-7-hexadecene, 1-amino-8-hepta-decene, 1-amino-9-heptadecene 1-amino-9-hexadecene, 1-amino-9-eicosene, 1-amino-9,12-octadecadien, 1-amino-8,11-heptadecadiene, 1-amino-13-docosene, N-9-octadecenyl-propanediamine, N-octyl-2,7-octadienyl-amine, N-9-octadecen-1-yl-9-octa-decen-1-amine(dioleylamine), bis(2,7-octadienyl)amine, and N,N-dibutyl-2,7-octa-dienylamine.

41. The method of claim 37, wherein the cadmium compound is selected from the group consisting of cadmium oxide, an inorganic cadmium salt and an organic cadmium salt.

42. The method of claim 41, wherein the organic cadmium salt is selected from the group consisting of cadmium acetate (Cd(Ac)₂), cadmium stearate and cadmium oleate.

43. The method of claim 41, wherein the inorganic cadmium salt is cadmium carbonate (CdCO₃).

44. The method of claim 37, further comprising adding a surfactant.

45. The method of claim 44, wherein the surfactant is selected from the group consisting of an organic carbonic acid, an organic phosphate, an organic phosphonic acid and mixtures thereof.

46. The method of claim 41, wherein forming a solution of a cadmium compound further comprises adding a surfactant, wherein the surfactant is a organic carbonic acid, thereby allowing the formation of a cadmium salt of the carbonic acid.

47. The method of claim 45, wherein the organic carbonic acid is selected from the group consisting of stearic acid (octadecanoic acid), lauric, acid, oleic acid ([Z]-octadec-9-enoic acid), n-undecanoic acid, linoleic acid, ((Z,Z)-9,12-octadecadienoic acid), arachidonic acid ((all-Z)-5,8,11,14-eicosatetraenoic acid), linelaidic acid ((E,E)-9,12-octadecadienoic acid), myristoleic acid (9-tetradecenoic acid), palmitoleic acid (cis-9-hexadecenoic acid), myristic acid (tetradecanoic acid), palmitic acid (hexadecanoic acid), γ-homolinolenic acid ((Z,Z,Z)-8,11,14-eicosatrienoic acid) and mixtures thereof.

48. The method of claim 44, wherein the surfactant is added before the element A is added.

49. The method of claim 37, wherein the solvent further comprises a non-coordinating compound.

50. The method of claim 49, wherein the non-coordinating compound is an alkene and/or an alkane.

51. The method of claim 37, wherein the solvent comprises an alkene and an amine, and wherein the ratio of the alkene and the amine is from about 1:10 to about 10:1.

52. The method of claim 51, wherein the alkene is selected from the group consisting of 1-hexadecene, 1-heptadecene, 1-octadecene, 1-eicosene, 1,17-octadecadiene and mixtures thereof.

53. The method of claim 37, wherein the solvent further comprises a phosphine.

54. The method of claim 37, wherein the solvent comprises an amine and a phosphine, and wherein the ratio of the amine and the phosphine is from about 1:10 to about 10:1.

55. The method of claim 37, wherein the reaction temperature is about 80° C., about 100° C., or about 120° C.

56. A method of forming a nanocrystal of the composition CdA, wherein A is S or Se, the method comprising:
(a) forming in a suitable solvent a solution of cadmium, or a compound thereof, in a form suitable for the generation of a nanocrystal at a temperature selected in the range from about 100° C. to 250° C., wherein said solvent is selected from the group consisting of dioctyl ether, 1-octadecene, oleylamine and a combination thereof
(b) bringing the solution to a reaction temperature selected in the range from about 40° C. to about 120° C.,
(c) adding at the reaction temperature selected in the range from about 40° C. to about 120° C. the element A in a form suitable for the generation of a nanocrystal, thereby allowing the forming of a nanocrystal of the composition CdA.

57. A method of manufacturing an illuminant comprising contacting a nanocrystal obtained by the method as defined in claim 37 with a suitable substrate material.
